(19) United States
(12) Patent Application Publication
(10) Pub. No.: US 2009/0095103 A1
(43) Pub. Date: Apr. 16, 2009

(54) Two-part gearwheel

(76) Inventors: Thomas Duzzie, Rochester Hills, MI (US); Harald Gieb, Weinstadt (DE); Lawrence Kennedy, Bingham Farms, MI (US)

Correspondence Address: KLAUS J. BACH, 4407 TWIN OAKS DRIVE, MURRYSVILLE, PA, 15668, US

(21) Appl. No.: 11/974,187

(22) Filed: Oct. 11, 2007

(51) Int. Cl. F16H 55/18

(52) U.S. Cl. 74/409

(57) ABSTRACT

In a two-part gear wheel, including a first spur gear ring which is connected to a hub and a second spur gear ring which is rotatable relative to the first spur gear ring, annular spring elements are provided biasing the spur gear rings in opposite rotational directions. The ends of the two annular spring elements are in engagement with the spur gear ring and the hub at locations spaced circumferentially by about 180° so that the spring forces effective on the second spur gear ring compensate each other circumferentially.

### BACKGROUND OF THE INVENTION

The invention relates to a two-part gearwheel including two gear rings supported rotatably relative to each other. Such a two-part gearwheel is used in a backlash-free spur-wheel stage. It comprises two spur gear rings, of which the first spur gear ring is considered to be fixed, for example is connected to a hub, through which, in turn, a shaft passes, and of which the second spur gear ring is movable coaxially with respect to the first spur gear ring, in order to ensure backlash compensation when the tooth-flank backlash is excessive when the two-part gearwheel meshes with another gearwheel. A spring pre-stresses the second spur gear ring against the first spur gear ring in the circumferential direction. When the two-part gearwheel meshes with another gearwheel, the first spur gear ring then touches a front tooth flank and the second spur gear ring a rear tooth flank of the other gearwheel, so that backlash is minimized.

A two-part gearwheel of the type mentioned is known from DE 10 2004 008 171 A1 and DE 201 04 777 U1. In DE 10 2004 008 171 A1, two rectilinear springs are used, which, as seen axially, engage bolts that extend from the front into the spur gear rings. In DE 201 04 777 U1, an annular spring surrounding the hub is used. So that the annular spring can engage the spur gear rings, stops are provided on the spur gear rings.

The rectilinear springs cannot however transmit force optimally between the two spur gear rings. In the embodiment with the annular spring, the stops likewise do not ensure optimal force transmission, and, moreover, the provision of the stops is complicated.

It is the object of the present invention to provide a two-part gearwheel in such a way that force transmission between the two spur gear rings is optimized, the design being compact, cost-effective and easy to assemble.

### SUMMARY OF THE INVENTION

In a two-part gear wheel, including a first spur gear ring which is connected to a hub and a second spur gear ring which is rotatable relative to the first spur gear ring, annular spring elements are provided biasing the spur gear rings in opposite rotational directions. The ends of the two annular spring elements are in engagement with the spur gear ring and the hub at locations spaced circumferentially by about 180° so that the spring forces effective on the second spur gear ring compensate each other circumferentially.

In comparison with the two-part gearwheel of DE 201 04 777 U1, there are no stop bolts but rather grooves are provided. The grooves in the hub and in the second spur gear ring can be formed much more easily than corresponding stops, and force transmission takes place optimally.

In a particular embodiment of the invention, two springs are used which in each case extend over a ring segment. If only one spring would be used as in DE 201 04 777 U1, the second spur gear ring would be loaded on one side during the tensioning of the spring and would be pressed against the bearing journal so that it would be tilted. This is avoided by the use of two springs.

The annular springs are preferably offset with respect to one another in such a way that they engage the hub and the second spur gear ring at locations offset at 180° with respect to one another. If the embodiment with the grooves formed in the hub and in the second spur gear ring is used, two grooves offset at 180° with respect to one another are correspondingly provided in the hub and two grooves offset at 180° with respect to one another are likewise provided in the second spur gear ring. With two annular springs (which do not have to extend around a complete ring) being used, of the forces of the individual spring are optimally compensated for by the other spring in each case, with the result that the spur gear rings are subjected to a particularly low load.

In DE 201 04 777 U1, the angular spring is placed into the second spur gear ring. In a particular embodiment according to the present invention, all the springs, which naturally have to extend over a ring segment, are received in an annular groove, the annular groove being formed, in particular, in the second spur gear ring. As a result, the mounting of the springs becomes easier, the springs have a particularly good hold, and, when the embodiment in which the end portions projecting from the springs extend into grooves is used, the springs, by being received in an annular groove, can be positioned particularly well in relation to the grooves in the hub or the second spur gear ring, so that the forces are transmitted optimally.

A preferred embodiment of the invention is described below with reference to the drawing in which

### BRIEF DESCRIPTION OF THE DRAWINGS

FIG. 1 is a perspective view of a two-part gearwheel according to the invention,

FIG. 2 is a top view of the gearwheel of FIG. 1, and

FIG. 3 is an axial sectional view of through the gearwheel of FIG. 2.

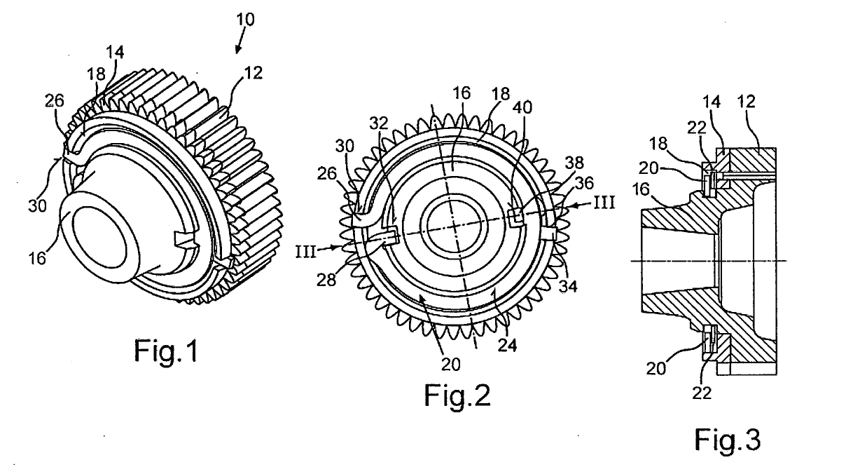

### DESCRIPTION OF A PARTICULAR EMBODIMENT

A two-part gearwheel, designated as a whole by the reference numeral 10, comprises a first spur gear ring 12 and a second spur gear ring 14. The first spur gear ring 12 is connected fixedly to a hub 16 in order thereby to form a spur gear part which is stationary relative to the hub 16. The second spur gear ring 14 surrounds the hub 16 and is seated on the first spur gear ring 12. In the second spur gear ring 14, an annular groove 18 is formed. The annular groove 18 is sufficiently deep to make it possible to receive two annular spring elements 20 and 22.

As can be gathered from FIG. 3, the annular spring elements 20 and 22 consist of a flat elastic material. As can be seen in FIG. 2, the annular spring element 20 comprises a ring segment 24, from which a first end portion 26 projects radially outwardly at one end and a second end portion 28 projects radially inwardly at the other end. The ring segment 24 extends over approximately 320° to approximately 340°, that is to say over almost the whole circle. The end portion 26 of the annular spring element 20 which projects radially outwardly from the ring segment 24 extends into a groove 30 in the second spur gear ring 14. The end portion 28 projecting radially inwardly from the ring segment 40 at the other end of the annular spring element 20 extends into a groove 32 in the hub 16. The second spur gear ring 14, which is movable coaxially with respect to the first spur gear ring 12, is therefore biased against the spur gear ring 12 in the circumferential direction by the annular spring element 20. As is known from two-part gearwheels, the tooth-flank backlash, which occurs when the two-part gearwheel 10 meshes with a further gearwheel, not shown in the figures, can thus be eliminated.

The second annular spring element 22 is constructed in exactly the same way as the first annular spring element 20, but is offset at 180° with respect to the latter in the annular groove 18. This means that a perpendicularly projecting end portion 34, as seen in FIG. 2, of the second annular spring element 22 extends into a groove 36 which is formed in the spur gear ring 14 but which is offset by 180° with respect to the groove 30. The end portion 34 of the annular spring element 22 in this case corresponds to the end portion 26 of the annular spring element 20. An end portion 38 of the annular spring element 22, which corresponds to the end portion 28 of the annular spring element 20, projects perpendicularly inwardly into a groove 40 in the hub 16, the groove 40 being offset by 180° with respect to the groove 32.

Since at the same time the annular groove 18 receives two annular spring elements 20 and 22 which, on one hand, engage, offset by 180°, the hub 16, and, on the other hand, offset by 180°, the second spur gear ring 14, the forces applied by the annular spring elements 20 and 22 are distributed particularly optimally, and tilts, tipping, etc. of the spur gear ring 14 do not occur, contrary to what often happens in the prior art arrangements. The two annular spring elements 20 and 22 can easily be installed in the annular groove 18 and are retained therein without further aids.

What is claimed is:

1. A two-part gearwheel (10) including a first spur gear ring (12) and a second spur gear ring (14), the second spur gear ring (14) being supported so as to be rotatable coaxially with and relative to, the first spur gear ring (12), and two springs (20, 22) each comprising a ring segment (24), having ends with radially outwardly and, respectively, inwardly projecting end portions (26, 34; 28, 38), one end portion (28, 38) of each spring extending into a groove (32, 40) formed in a hub connected to the first spur gear ring (12) and the other end portion (26, 34) extending into a groove (30, 36) in the second spur gear ring (14).

2. The two-part gearwheel according to claim 1, wherein each of the two springs (20, 22) includes a ring segment extending over the end portions of the other spring.

3. Two-part gearwheel according to claim 2, wherein the two springs (20, 22) each have end portions (26, 34; 28, 38) which in each case extend into grooves (30, 36; 32, 40), two (32, 40) of the grooves extending into the hub (16) and the other grooves (30, 36) being provided in the second spur gear ring (14), said grooves being offset by 180° with respect to one another.

4. The two-part gearwheel according to claim 1, wherein, the springs (20, 22) are received in a single annular groove (18) formed in the hub (16) and in the second spur gear (14).
